(19) United States
(12) Patent Application Publication
(10) Pub. No.: US 2015/0234575 A1
(43) Pub. Date: Aug. 20, 2015

(54) SYSTEM AND METHOD FOR CONTROLLING SMART DEVICE MIRRORING OF HEAD UNIT FOR VEHICLE

(71) Applicant: Hyundai Motor Company, Seoul (KR)

(72) Inventor: Jae Min Suk, Seongnam (KR)

(21) Appl. No.: 14/548,156

(22) Filed: Nov. 19, 2014

(30) Foreign Application Priority Data
Feb. 18, 2014 (KR) 10-2014-0018206

(51) Int. Cl. G06F 3/0484; G06F 3/0482; H04L 29/08; G06F 3/0481

(52) U.S. Cl. CPC G06F 3/04842; G06F 3/04817; G06F 3/0482; H04L 67/12

(57) ABSTRACT

A system and method for controlling smart device mirroring of a head unit for a vehicle are provided. The present system and method allow events such as transmitted coordinates and button key push to be executed in a first smart device, by allowing a sensor provided as an interface on a first operating system framework to determine whether an event of a touch/button device has occurred and transmitting the button key value and the coordinates of the occurring event to a digital second smart device out part through an interface.

### CROSS-REFERENCE TO RELATED APPLICATION

This application claims under 35 U.S.C. §119(a) the benefit of Korean Patent Application No. 10-2014-0018206 filed Feb. 18, 2014, the entire contents of which are incorporated herein by reference.

### BACKGROUND

(a) Technical Field

The present invention relates to a system and method for controlling smart device mirroring of a head unit for a vehicle. More particularly, the present invention relates to a system and method for controlling smart device mirroring of a head unit for a vehicle, which performs a simplified event information delivery process of a digital iPOD out that is one of smart device mirroring technologies for a vehicle on an ANDROID platform.

(b) Background Art

An Audio, Video and Navigation (AVN) system for a vehicle is a multimedia system in which a telematics unit including navigation, a video unit, and an audio unit in addition to a head unit are integrated into one unit. The AVN system can provide a user convenience that enables intensive manipulation of various multimedia devices and can effectively utilize spaces such as an instrument panel and a center fascia of a vehicle. Recently, systems of accessing and providing various types of services provided from a mobile or Internet environment are being applied to the head unit. As an example of the systems, a mirroring technology in which a screen of a smart device (e.g., a smart phone) is touchably and identically (e.g., the smart phone screen is mirrored onto the vehicle display) displayed on a display in a vehicle is being applied.

The mirroring technology for a vehicle allows the screen of a smart device carried by a driver to be identically displayed on the display in a vehicle without directly operating the smart phone, and provides a driver with conveniences, allowing a driver to touch the display in a vehicle to operate the smart device. To apply the smart device mirroring technology, a head unit mounted within a vehicle is installed with an operating system of ANDROID or APPLE. For an iPHONE or iPOD, iOS which is the operating system of APPLE is to be installed to operably display high-tech iPOD functions. However, when the ANDROID operating system is installed in the head unit and an iPHONE or iPOD (e.g., any APPLE device) is connected to the head unit for mirroring, a separate iPOD out technology (e.g., technology of identically displaying the screen of a device with iOS on the display in a vehicle) is required.

Hereinafter, a process of executing the iPOD out function in a typical ANDROID platform will be described with reference to FIG. 1. The execution of the iPOD out function on the ANDROID platform partially using the LINUX kernel is based on userspace implementation of devfs (udev) provided for the LINUX platform. For reference, the udev, which is a daemon for the booting and management of devices under the ANDROID environment, provides a dynamic device directory including only files for devices that actually exist as libraries for the device registration, and performs automation processing of file node creation for devices that actually exist in the user space and performs dynamic processing of deletion and creation of device files.

In FIG. 1, the reference numeral 10 denotes a head unit of a vehicle, and the reference numerals 20 and 30 denote LINUX kernel and digital iPOD out parts that are ported in the head unit, respectively. First, a signal of a touch or a button push through a touch/button device (e.g., head unit) is delivered to the LINUX kernel simultaneously with the startup of a vehicle (S101). In particular, the LINUX kernel 20 includes a device register 12 configured to register the touch/button device and an event register 14 configured to monitor and create events of the touch/button device.

Further, when the touch or butting signal is generated through the touch/button device, the device that generates the touch or button signal is registered in the device register 12. In other words, the device that generates the touch or button signal is registered in a sysfs file system of the LINUX kernel to allow a user to access the device (S102). When the device is registered in the sysfs file system, a system directory (/sys) is created while the device is stored in a user area of the sysfs file system in a form of file (S103).

Meanwhile, after the registration of the touch/button device is completed, udevd (udev daemon) monitors whether an event occurs, i.e., whether or not a touch or button operation signal is present, delivering the generated event to the udevd (udev daemon) of the event register 14 (S104). In particular, the event content and the corresponding device are read from the system directory (/sys) (S105). While the node of the touch/button device is created, a dev directory (/dev) is created to store the event (touch or button operation) in a form of file (S106). The event stored in the dev directory is delivered to an udev event processor (S107). In addition, based on information of sysfs collected in the system directory, a device of an udev form is created, and the created udev device is delivered to the udev event processor (S108).

Meanwhile, when an APPLE device (hereinafter, referred to as iPHONE) is connected to the head unit of a vehicle, the digital iPOD out part 30 is executed. First, a Human Interface Device (HID) of the digital iPOD out part 30 provided by APPLE is executed, and an udev device is created similarly to the creation of the udev device performed in the LINUX kernel 20. In particular, to create the udev device in the digital iPOD out part 30, the HID creates a handler for monitoring udev (S201), and creates the udev device (S202). Further, a descriptor is created for the created udev device (S203), and then is registered in the udev. For example, a touchscreen descriptor is registered in the udev to create the udev device (S204), and button devices (SIRI, seek, and call/reject) are also registered in the udev (S205). Thus, various types of touch and button devices of the iPHONE are created as udev devices, and then are delivered to the udev event processor. Accordingly, the event processor matches the udev device created in the device register 12 with the udev device created in the digital iPOD out part 30 (S109).

Consecutively, the creation location (e.g., touch coordinates (x,y) and button key push (on)) of the event delivered from the dev directory of the event register 14 regarding the mutually matched udev devices is transmitted to the digital iPOD out part 30 in a report form (FillReport(Touch, Button)). Finally, in the digital iPOD out part 30, the event creation coordinates and the button key push signal are transmitted to the iPHONE, and events such as the transmitted coordinates and button key push are actually executed in the iPHONE. Mirroring in which the execution screen of the iPHONE is identically displayed on the display of the head unit is then performed.

However, since the udev is substantially complex and is a library that causes a substantially large load to a system, various tests are required. Accordingly, when the digital iPOD out technology is applied to the head unit of the AVN system for a vehicle, extensive time and effort are required to port udev in the device (head unit). Particularly, since the updated version of ANDROID (e.g., Jelly Bean) omits udev itself and does not support udev, the design of the iPOD out technology for mirroring requires modification. Additionally, the udev is deleted from the ANDROID kernel since the udev is complex in structure and substantially slow in speed. Since all versions of ANDROID released in future are expected to omit udev, a new iPOD out technology on the ANDROID platform is required.

The above information disclosed in this section is merely for enhancement of understanding of the background of the invention and therefore it may contain information that does not form the prior art that is already known in this country to a person of ordinary skill in the art.

### SUMMARY

The present invention provides a system and method for controlling smart device mirroring of a head unit for a vehicle, which allows events such as transmitted coordinates and button key push to be executed in an iPHONE, by allowing TouchListener and KeyListener provided as interfaces on an ANDROID framework to determine whether an event of a touch/button device occurs and transmitting the button key value and the coordinates of the occurring event to a digital iPOD out part via a Java Native Interface (JNI).

In one aspect, the present invention provides a system for controlling smart device mirroring of a head unit for a vehicle that may include: a KeyListener and a TouchListener configured to monitor an event occurrence of a touch/button device; a Java native interface configured to convert event information monitored by the KeyListener and the TouchListener into a form usable in a digital iPOD out part; and the digital iPOD out part configured to report coordinates and button key of the event information transmitted from the Java native interface into a signal recognizable in an iPHONE.

In another aspect, the present invention provides a method for controlling smart device mirroring of a head unit for a vehicle that may include: monitoring, by a KeyListener and a TouchListener, an event occurrence of a touch/button device; transmitting event information monitored by the KeyListener and the TouchListener to a Java native interface to be converted into a form usable in a digital iPOD out part; reporting coordinates and button key of the event information transmitted from the Java native interface to the digital iPOD out part into a signal recognizable in an iPHONE and transmitting the coordinates and button key to the iPHONE; and executing an event including the transmitted coordinates and button key in the iPHONE.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary flowchart illustrating a configuration and a control process of a typical smart device mirroring control system of a head unit for a vehicle according to the related art; and

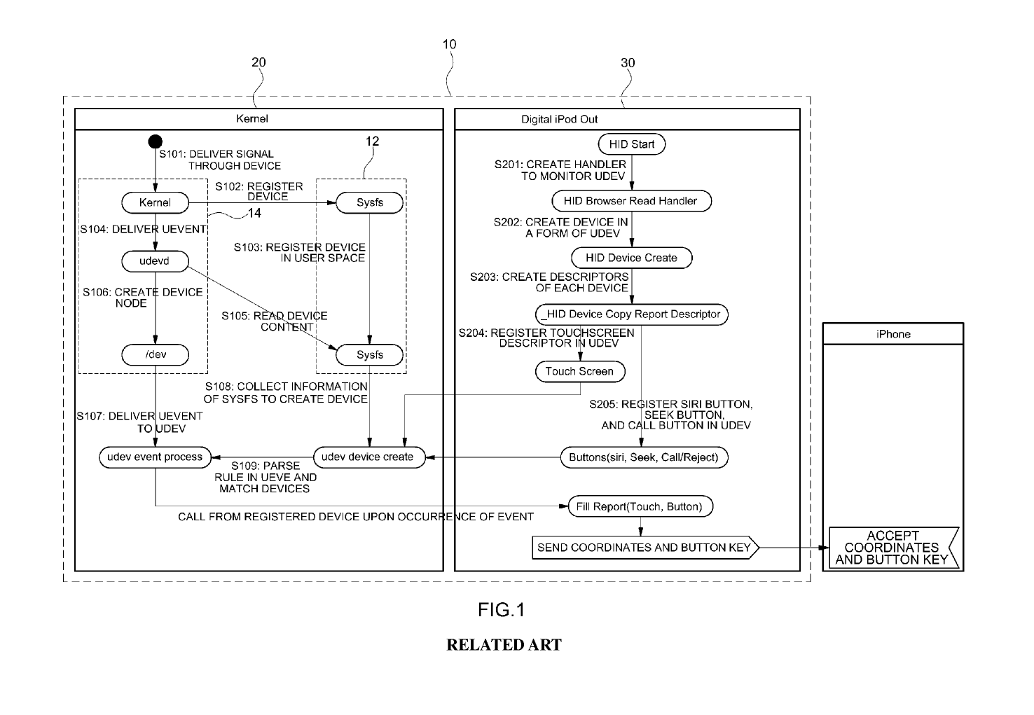

FIG. 2 is an exemplary flowchart illustrating a configuration and a control process of a smart device mirroring control system of a head unit for a vehicle according to an exemplary embodiment of the present invention.

Reference numerals set forth in the Drawings includes reference to the following elements as further discussed below:
10: head unit
12: device register
14: event register
20: LINUX kernel
30: digital iPOD out part
40: ANDROID application
50: Java native interface

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in detail with reference to the accompanying drawings so that those skilled in the art can easily carry out the present invention.

In case where an ANDROID operating system (e.g., a first operating system) is installed in a head unit for a vehicle, when iPHONE having an iOS unlike a smart device based on ANDROID (e.g., a second operating system different from the first operating system) is connected to the head unit for mirroring on a the display, a separate iPOD out (e.g., a second smart device out) technology is required to be applied. In the related art, the execution of the iPOD out function on the ANDROID platform (e.g., platform of a first smart device) partially using the LINUX kernel is based on userspace implementation of devfs (udev) provided for the LINUX platform. However, such a process is time consuming and requires substantial effort to port udev in the device (head unit). Particularly, since the updated version of ANDROID (e.g., Jelly Bean) omits udev and does not support udev, a new iPOD out technology on the ANDROID platform is required. Notably, throughout, the ANDROID device may be referred to as a first smart device (e.g., first smart phone) that operates on a first operating system and an iPHONE or iPOD may be referred to as a second smart device (e.g., a second smart phone) that operates on a second operating system that is different from the first operating system.

Accordingly, the present invention provides a simplified method of delivering an touch event and button key push that may include delivering event information to a Java Native Interface (JNI) (e.g., an interface) using TouchListener and KeyListener (e.g., a sensor or the like) provided as interfaces in an ANDROID framework, delivering event information (e.g., touch coordinates and button key (button key push)) to a library of a digital iPOD out part by the JNI, transmitting events to iPHONE with an HID descriptor and a report since typical udev is not used in the digital iPOD out part, and executing events such as the transmitted coordinates and button key push in iPHONE. In particular, the method described herein according to an exemplary embodiment of the present invention may be executed by a processor.

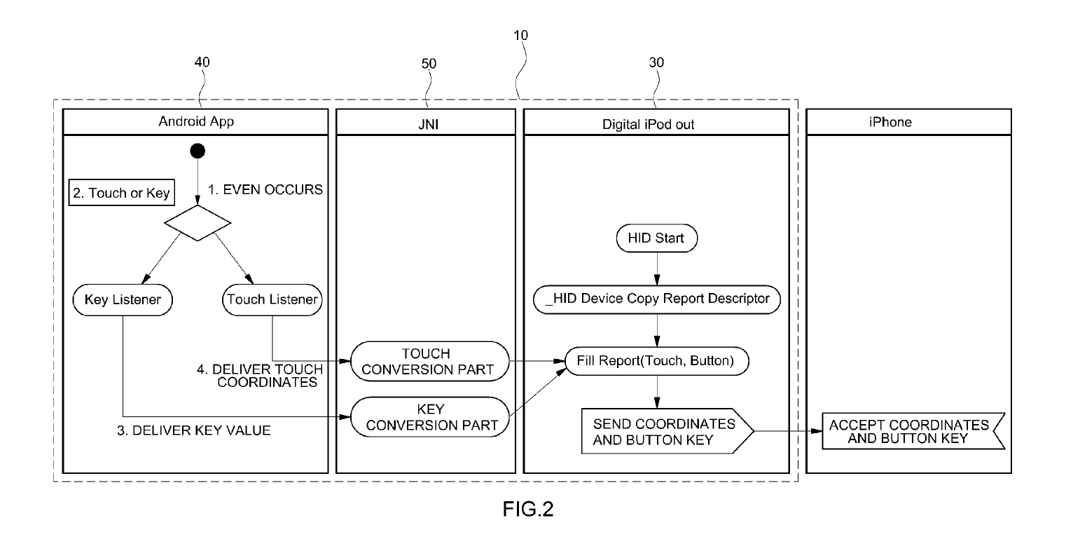

FIG. 2 is an exemplary flowchart illustrating a configuration and a control process of a smart device mirroring control system of a head unit for a vehicle according to an exemplary embodiment of the present invention. In FIG. 2, the reference numeral 10 may denote a head unit of a vehicle, and the reference numeral 40 may denote an ANDROID application. In addition, the reference numeral 50 may denote a Java Native Interface (JNI) that connects between the ANDROID application and the digital iPOD out part.

When an iPHONE is connected to a digital iPOD out part 30 of the head unit 10, although not shown, the screen of the iPHONE may be identically mirrored on the screen of the head unit 10. When a user intends to execute a specific function of the iPHONE, a user may touch the display screen or buttons adjacent thereto. Thus, an iPOD out function in which the specific function of the iPHONE connected to the digital iPOD out part 30 of the head unit 10 is performed may be executed. In particular, since the head unit 10 may have an ANDROID platform installed thereon, a separate touch and button event delivery method for executing the iPOD out function may be required.

Accordingly, the present invention may be focused on a point where event information is monitored using TouchListener and KeyListener (e.g., a sensor) provided as interfaces on the ANDROID framework and a where the monitored event information is delivered to a library of the digital iPOD out part using JNI (e.g., an interface). The KeyListener and the TouchListener, which may be provided as interfaces on the ANDROID framework, may be installed in the head unit 10 as an ANDROID application to monitor in real-time an event occurrence (e.g., occurrence of touch and button push, that is pressure applied to the screen) of a touch/button device (e.g., head unit). The JNI 50 may serve as an interface configured to convert the event information monitored by the KeyListener and the TouchListener into a form usable in the digital iPOD out part and deliver the converted event formation to the digital iPOD out part. The digital iPOD out part 30 may be configured to report (e.g., transmit) the coordinates and the button key of the event information transmitted from the JNI into a signal recognizable in an iPHONE, and may be configured to transmit the signal to the iPHONE.

Hereinafter, a series of processes of more easily delivering touch and button events to an iPHONE through the digital iPOD out part will be described as a smart device mirroring control method of a head unit for a vehicle according to an exemplary embodiment of the present invention. First, the KeyListener and the TouchListener installed in the head unit as an ANDROID application may be configured to monitor in real-time an event occurrence (e.g., occurrence of touch and button push) of a touch/button device (e.g., head unit). Further, the event information (e.g., touch coordinates and button key) of the touch/button device monitored by the KeyListener and the TouchListener may be delivered to the JNI.

The JNI, which is an interface for communication with applications widely used under the Java environment, may be configured to convert the event information monitored by the KeyListener and the TouchListener into a form usable in the digital iPOD out part and may be configured to deliver the converted event formation to the digital iPOD out part. In other words, the JNI may be configured to convert the event information (e.g., touch coordinates and button key) provided from the KeyListener and the TouchListener as the Java language into C/C++ language recognizable in the digital iPOD out part, and deliver the C/C++ language to the digital iPOD out part. In particular, when an iPHONE is connected to the digital iPOD out part 30, a Human Interface Device (HID) provided by APPLE may be executed, and a descriptor with respect to the corresponding iPHONE may be created.

Moreover, when the coordinates and the button key of the event information are delivered from the JNI 50 to the digital iPOD out part 30, the digital iPOD out part 30 may be configured to report the coordinates and the button key of the event information into a signal recognizable in the iPHONE, and transmit the signal to the iPHONE. Accordingly, an event that includes the coordinates and the button key transmitted to the iPHONE may be executed in the iPHONE. In other words, when the digital iPOD out part 30 transmits the coordinates and button key push signal to the iPHONE, events such as the transmitted coordinates and button key push may be executed in the iPHONE, and simultaneously, the execution screen of the iPHONE may be identically displayed on the display of the head unit, thereby enabling mirroring.

Thus, since the udev which is substantially complex and causes a substantially large load to a system may be omitted, a time limitation and substantial effort to port udev in the device (head unit) may be improved. Particularly, when considering that all versions of ANDROID released in future are expected to omit udev, a more simplified iPOD out technology on the ANDROID platform may be achieved using TouchListener and KeyListener provided as interfaces on the ANDROID framework and simultaneously using the JNI.

The present invention provides the following effects.

First, since a typical complicated udev may be omitted for a digital iPOD out technology, the development time may be decreased, and the development cost may be reduced.

Second, since due to the use of KeyListener and TouchListener provided as interfaces on the ANDROID framework, procedures of registering a device through LINUX kernel and registering an event may be omitted, a mirroring system may be stably maintained.

Third, compared to udev occupying a substantially large amount of resources, CPU and RAM may be minimally used.

Fourth, compared to a typical case where a daemon, udev is always put on the LINUX kernel and a device is required to be created and managed inside the digital iPOD out, since mirroring may be performed on a display of a head unit through a simplified process of using an ANDROID framework including JNI, the touch feeling on the screen may be improved upon mirroring, and the response speed may be increased.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A system for controlling smart device mirroring of a head unit for a vehicle, comprising:
a sensor configured to monitor an event occurrence of a touch/button device;
an interface configured to convert event information monitored by the sensor into a form usable in a digital second smart device part; and
wherein the digital second smart device out part is configured to report coordinates and button key of the event information transmitted from the interface into a signal recognizable by the second smart device.

2. The system of claim 1, wherein the sensor is an interface on a first operating system framework, and is installed in the head unit as a first smart device application.

3. The system of claim 1, wherein the interface is adopted to convert the event information provided in a computer language usable in the digital second smart device out part.

4. A method for controlling smart device mirroring of a head unit for a vehicle, comprising:
monitoring, by a processor, using a sensor, an event occurrence of a touch/button device;
transmitting, by the processor, event information monitored by the sensor to an interface to be converted into a form usable in a digital second smart device out part;
reporting, by the processor, coordinates and button key of the event information transmitted from the interface to the digital second smart device out part into a signal recognizable by the second smart device and transmitting the coordinates and button key to the second smart device; and
executing, by the processor, an event comprising the transmitted coordinates and button key in the second smart device.

5. The method of claim 4, wherein the sensor is provided as an interface on a first operating system framework.

6. The method of claim 4, wherein the interface converts the event information provided in a computer language usable in the digital second smart device out part.

7. A non-transitory computer readable medium containing program instructions executed by a processor, the computer readable medium comprising:
program instructions that monitor using a sensor, an event occurrence of a touch/button device;
program instructions that transmit event information monitored by the sensor to an interface to be converted into a form usable in a digital second smart device out part;
program instructions that report coordinates and button key of the event information transmitted from the interface to the digital second smart device out part into a signal recognizable by the second smart device and transmitting the coordinates and button key to the second smart device; and
program instructions that execute an event comprising the transmitted coordinates and button key in the second smart device.

8. The non-transitory computer readable medium of claim 7, wherein the sensor is provided as an interface on a first operating system framework.

9. The non-transitory computer readable medium of claim 7, wherein the interface converts the event information provided in a computer language usable in the digital second smart device out part.
